(19) United States
(12) Patent Application Publication
(10) Pub. No.: US 2010/0254561 A1
(43) Pub. Date: Oct. 7, 2010

(54) MICROPHONE DEVICE

(75) Inventors: Norio KIMURA, Kanagawa (JP); Hiroshi Ogura, Tokyo (JP); Yusuke Takeuchi, Kanagawa (JP)

Correspondence Address: MCDERMOTT WILL & EMERY LLP, 600 13TH STREET, NW, WASHINGTON, DC, 20005-3096, US

(73) Assignee: Panasonic Corporation, Osaka (JP)

(21) Appl. No.: 12/821,659

(22) Filed: Jun. 23, 2010

Related U.S. Application Data
(63) Continuation of application No. PCT/JP2009/001146, filed on Mar. 13, 2009.

(30) Foreign Application Priority Data
Mar. 19, 2008 (JP) 2008-072011

(51) Int. Cl. H04R 19/04

(52) U.S. Cl. 381/369

(57) ABSTRACT

Provided is a microphone device, i.e., an acoustic sensor, with high reliability for reducing noise caused by light. A microphone device includes: a condenser including a first electrode, and a second electrode opposite to the first electrode, the first electrode and the second electrode are provided on a semiconductor substrate; an amplifier which is electrically connected to the condenser. Each of the first electrode and the second electrode has the same conductivity type as the semiconductor substrate.

### TECHNICAL FIELD

The present invention relates to a microphone device, and particularly to reductions in noise of the microphone device.

### BACKGROUND ART

An electret condenser microphone (ECM) is a miniature acoustic transducer which detects a change in capacity of the condenser caused by sound waves as an electrical signal and which uses an electret film having semipermanent polarization, thereby eliminating the need for a DC bias of a condenser. In recent years, there is proposed a technique for forming a microminiature condenser microphone by micromachining a silicon substrate rather than assembling machine components (for example, Patent Reference 1).

The condenser microphone of silicon which is manufactured using a manufacturing technique of the so-called MEMS (microelectromechanical systems) element is called “a silicon microphone (or a silicon mic)”, and the technique has attracted attention as a manufacturing technique of the ECM for being installed in a mobile telephone terminal etc. becoming smaller and thinner (see for example, Patent Reference 1).

Here, the silicon microphone is manufactured by processing the silicon substrate using a semiconductor process technique. Therefore, generally, the silicon microphone is formed by a thin film process using the silicon substrate as a starting material.

FIG. 6 shows one example of an MEMS microphone M. The MEMS microphone M is formed on a silicon substrate by simultaneously incorporating multiple microphone chips and individually separating the microphone chips finally using a semiconductor manufacturing technique. FIG. 6 shows a side view of a single separated microphone chip. The MEMS microphone M includes a diaphragm electrode 23 and an electret film 24 which are provided, for example, on a p-type silicon substrate 21 through a first insulating layer 22. The MEMS microphone M also includes a fixed electrode 26 having sound holes 27 formed therein, which is provided on the diaphragm electrode 23 and an electret film 24 through a second insulating layer 25. A back air chamber 28 is formed in a back surface of the diaphragm electrode 23 by etching the silicon substrate 21.

The diaphragm electrode 23 is formed by polysilicon which has conductivity by n-doping. The electret film 24 is formed by a silicon nitride film or a silicon oxide film. The fixed electrode 26 is formed by laminating the silicon oxide film or the silicon nitride film and the polysilicon having conductivity by n-doping.

In the MEMS microphone M, when the diaphragm electrode 23 is vibrated by a sound pressure, the electrostatic capacitance of the condenser configured by the diaphragm electrode 23 and the fixed electrode 26 changes, which is taken out as a change in voltage.

Patent Reference 1: JP-A-2004-354199 (Page 1, FIG. 1)

### DISCLOSURE OF THE INVENTION

### Problems that the Invention is to Solve

Incidentally, in the manufacturing field of the microphone or a speaker, sensitivity becomes an extremely important problem, and as a result of various verifications, the inventors found that the MEMS microphone placed in a steady blink of a fluorescent lamp (it is known that the blink has a frequency two times a commercial frequency) picked up noise. They found that light blinked by the fluorescent lamp in which the blink was periodically output at the frequency two times the commercial frequency was detected by the MEMS microphone.

The invention was made in view of the above circumstances and focuses on the finding described above, and an object of the invention is to provide an MEMS microphone, i.e., an acoustic sensor, capable of reducing noise caused by light and having high reliability.

### Means for Solving the Problems

The invention is characterized by a microphone device comprising: a condenser including a first electrode, and a second electrode, opposite to the first electrode, the first electrode and the second electrode being provided on a semiconductor substrate; an amplifier which is electrically connected to the condenser, wherein each of the first electrode and the second electrode has the same conductivity type as the semiconductor substrate.

As described above, the inventors focused on the finding that an output of the condenser included a signal output of the same frequency as that of a blink of a fluorescent lamp, and as a result of examination, the inventors gained insights that as an output of the condenser configured to detect a change in capacitance between the first electrode and the second electrode, a photoelectric conversion output resulting from a light signal might be detected in addition to a mechano-electrical conversion output by vibration resulting from a signal (hereinafter called an acoustic signal) resulting from sound, vibration and pressure. Hence, the inventors conducted various experiments, and found that the signals corresponding to the light and the sound, respectively, were obtained on one output signal line from a single sensor, by confirming with respect to the light a signal completely synchronized with on-off modulation of an LED light emitted from the LED that does not output sound, and also confirming with respect to the sound a signal corresponding to a sound of a speaker that does not output light.

In the invention, each of the first electrode and the second electrode is configured to have the same conductivity type as the semiconductor substrate, thereby suppressing the photoelectric conversion output caused by the light signal which is taken out by the presence of a PN junction.

Therefore, according to the configuration described above, each of the first electrode and the second electrode is configured to have the same conductivity type as the semiconductor substrate, whereby the photoelectric conversion output caused by the light signal can be suppressed, and noise can be reduced.

The invention also includes the microphone device further comprising a mounting substrate, a cap and a container defined by the mounting substrate and the cap, wherein the condenser and the amplifier are housed inside the container. And it is preferable that the microphone device further comprises the voltage supply terminal, the output terminal, the condenser electrode terminal and the ground terminal, which are led out of the container. And it is preferable that the cap has an opening which is disposed directly above the condenser.

The invention also includes the microphone device wherein the condenser and the amplifier are mounted on a first surface of the mounting substrate, and the ground terminal and the output terminal are arranged on a second surface of the mounting substrate, the second surface is opposite to the first surface. It is preferable that the voltage supply terminal, the output terminal, the condenser electrode terminal and the ground terminal are performed as surface-mounted terminals. So, the microphone device is used as a package, which is mounted on a substrate of the other device, for example a mobile phone.

The invention also includes the microphone device wherein the condenser electrode terminal connected to the second electrode of the condenser is connected to the ground terminal inside or outside the container.

The invention also includes the microphone device wherein the condenser unit includes an MEMS microphone.

The invention also includes the microphone device wherein the semiconductor substrate is made of n-type silicon substrate. And it is preferable that each of the first electrode and the second electrode is made of n-doped polysilicon. And it is preferable that an electret film is formed on the first electrode, the electret film is disposed between the first electrode and the second electrode. And it is preferable that the electret film and the first electrode are a diaphragm.

From various experiment results, it is found that the noise can be reduced in the case of shaping an n-type silicon substrate by an MEMS process and using an n-doped polysilicon layer as the electrode. Also, from a further experiment result, it is found effective in a case in which the silicon substrate of the first conductive type is used as a starting material, and the electrode is formed of silicon of the same conductivity type, i.e., the n-type.

The invention also includes the microphone device wherein the MEMS microphone is formed on an n-type single-crystal silicon substrate, and the first and second electrodes are formed of an n-type polycrystalline silicon film grown on the single-crystal silicon substrate.

According to the configuration described above, a thin microphone device with low noise and high sensitivity can be provided extremely easily by simply adjusting dopant at the time of forming the film.

### ADVANTAGE OF THE INVENTION

According to the microphone device of the invention, a reduction in noise and miniaturization can be achieved and an output with high sensitivity can be obtained.

### BRIEF DESCRIPTION OF THE DRAWINGS

FIG. 1 is a conceptual explanatory diagram of a microphone device of a first embodiment of the invention;

FIG. 2 is an equivalent circuit diagram of the microphone device used in the first embodiment of the invention;

FIG. 3 is a diagram showing the microphone device used in the embodiment of the invention, and FIG. 3(a) is a top view, and FIG. 3(b) is a side view, and FIG. 3(c) is a bottom view;

FIG. 4 is a diagram showing an internal configuration of the microphone device used in the embodiment of the invention;

FIG. 5 is a diagram showing the microphone device used in the embodiment of the invention;

FIG. 6 is a cross-sectional view of an MEMS chip;

FIG. 7 is a diagram showing a result of measuring an output signal of an MEMS microphone;

FIG. 8 is a diagram showing an output by ON/OFF of LED light;

FIG. 9 is a diagram showing sensitivity characteristics in a case of changing magnitude of a voltage and polarity of a sensitivity control voltage; and

FIG. 10 is a diagram showing sensitivity frequency characteristics.

### DESCRIPTION OF REFERENCE NUMERALS AND SIGNS

10 Microphone device
21 Silicon Substrate
22 Insulating Layer
23 Diaphragm Electrode
24 Electret Film
25 Second Insulating Layer
26 Fixed Electrode
27 Sound Hole
28 Back Air Chamber
M MEMS Microphone

### BEST MODE FOR CARRYING OUT THE INVENTION

An embodiment of the invention will hereinafter be described in detail with reference to the drawings.

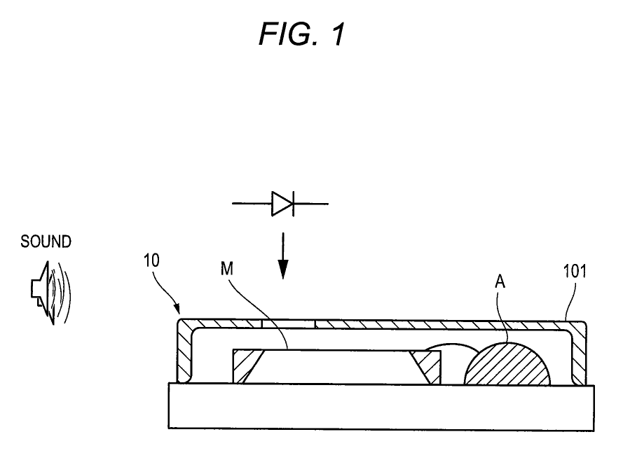

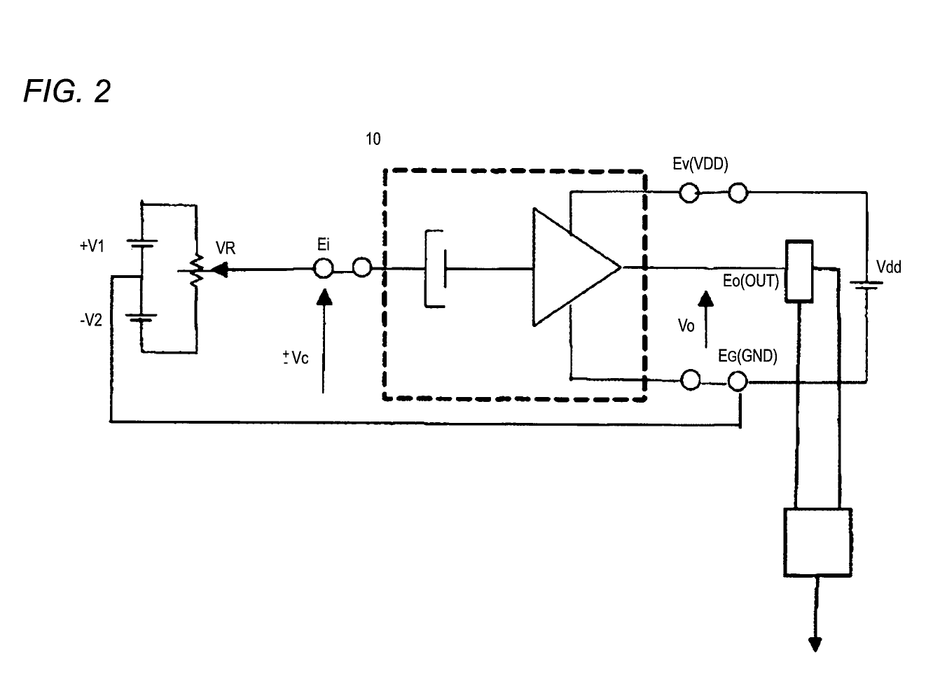

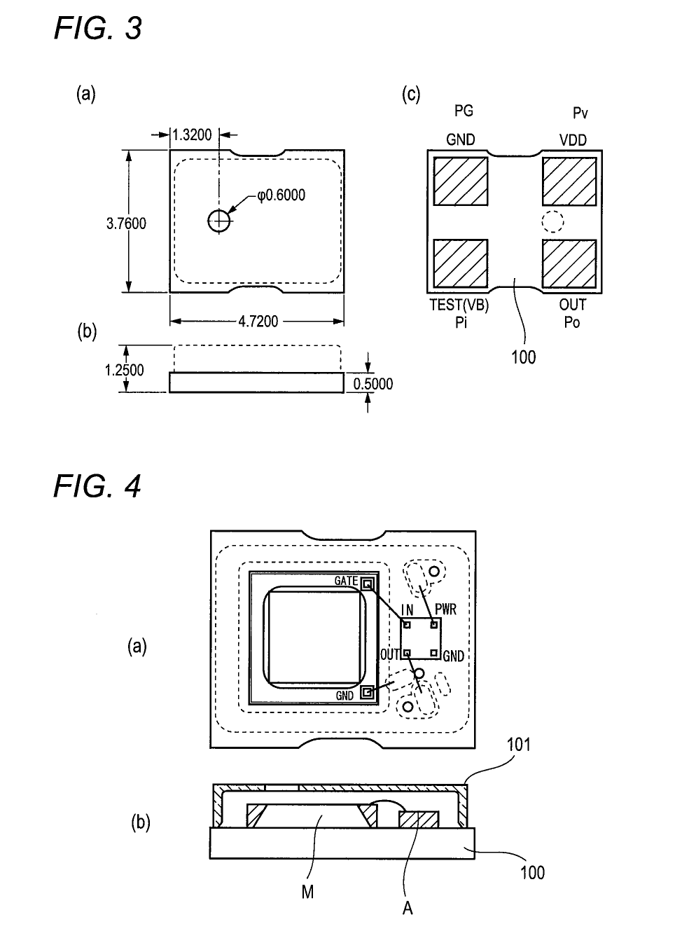

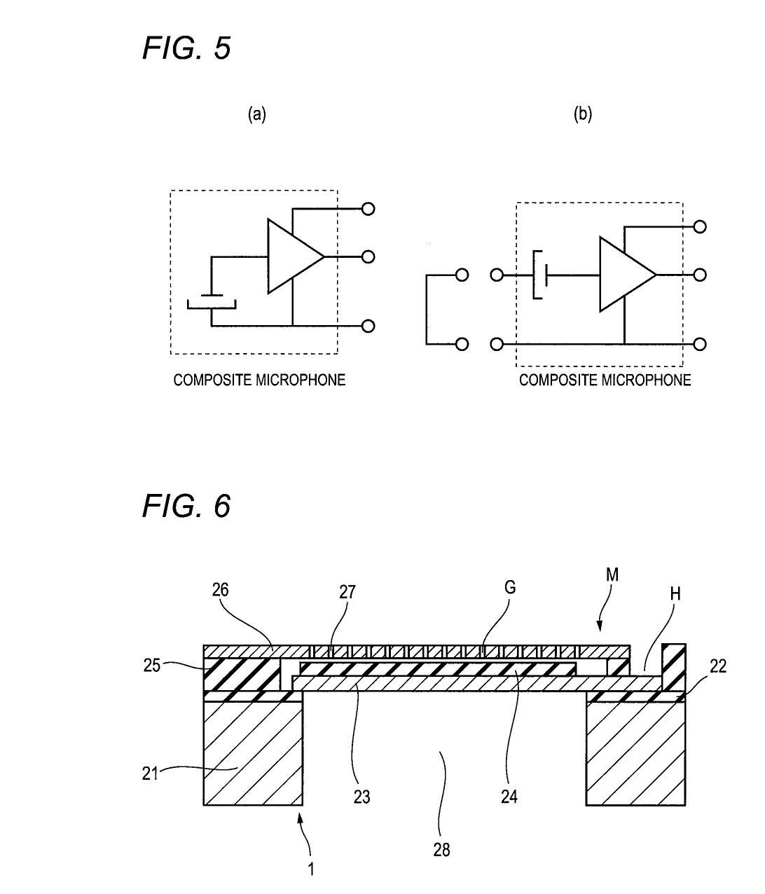

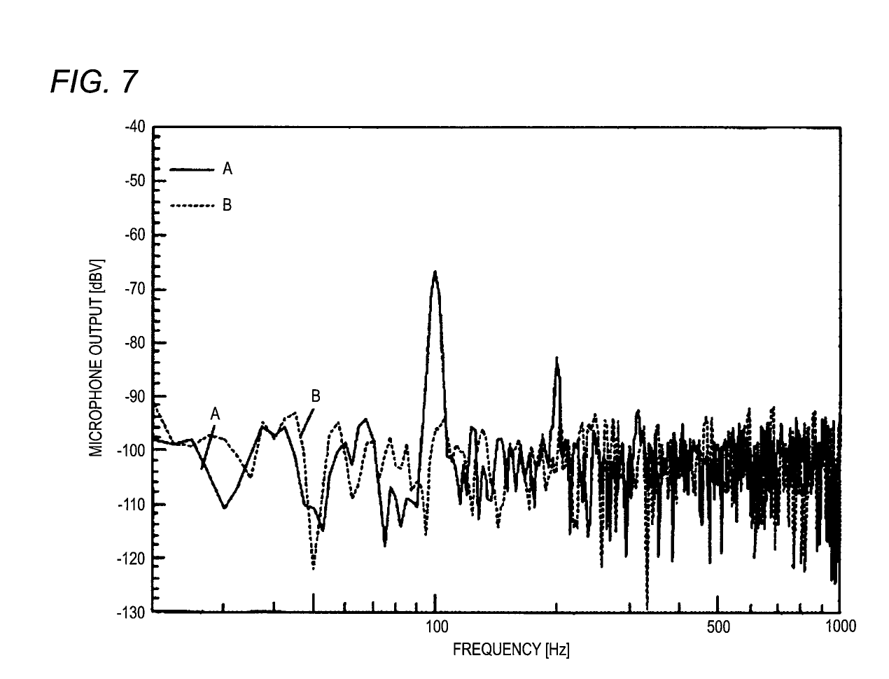

FIG. 1 is a schematic diagram showing a device configuration of a microphone device in the embodiment of the invention, and FIG. 2 is a configuration diagram of this microphone device, and FIGS. 3(a) to 3(c) are a top view, a side view and a bottom view of this microphone device, FIGS. 4(a) and 4(b) are a top view and a cross-sectional view showing an internal configuration of this microphone device, FIG. 5 is a connection example of electrode terminals, and FIG. 6 is a diagram showing a cross-sectional view of an MEMS chip.

As shown in FIG. 1, a microphone device 10 of the present embodiment is characterized by including an MEMS microphone chip M forming a condenser in which an electrode is formed by n-doped polysilicon while shaping an n-type silicon substrate. Further, sensitivity can be adjusted by separately leading out a condenser electrode terminal connected to a second electrode of the MEMS microphone chip M and a ground terminal, and applying a desired voltage across the ground terminal and the condenser electrode terminal. Numeral 101 denotes a metal cap, and A denotes a CMOS amplifier.

In this microphone device, as shown in FIG. 1 and FIGS. 4(a) and 4(b), the MEMS microphone (chip) M forming the condenser in which the electrode is formed by the n-doped polysilicon while shaping the n-type silicon substrate and the CMOS amplifier A connected to this MEMS microphone M and forming an amplifier are mounted on a circuit substrate 100 for mounting (a mounting substrate 100), and the MEMS microphone M and the CMOS amplifier A are sealed with the metal cap 101. As shown in FIG. 2 and FIGS. 3(a) to 3(c) illustrating an equivalent circuit diagram, the top view, the side view and the bottom view of this microphone device, the condenser M is connected to the CMOS amplifier A, and a condenser electrode terminal Eᵢ which is the second electrode of the condenser and a ground terminal E_{G} of the CMOS amplifier A are respectively taken out independently as a condenser electrode pad Pᵢ and a ground pad P_{G}, so as to form external terminals. Although details will be described below, as shown in FIG. 2, the condenser electrode terminal Eᵢ and the ground terminal E_{G} of the CMOS amplifier A are separately taken out, and a sensitivity control voltage containing a variable voltage VR of a sensitivity adjuster is connected between the condenser electrode pad Pᵢ and the ground pad P_{G}, whereby the microphone device is used as a sensitivity variable microphone. Pₒ denotes an output pad forming an output terminal Eₒ, and Pᵥ denotes a power source pad constructing a power source terminal Eᵥ.

As shown in FIG. 3, the microphone device may be configured such that the condenser electrode terminal Eᵢ which is the second electrode of the condenser and the ground terminal E_{G} of the CMOS amplifier A are connected inside the microphone device, for example, on its own circuit substrate or are connected in another circuit substrate at the time of mounting.

In this case, a microphone device of fixed sensitivity can be configured by using a film capable of holding a permanent charge as a dielectric film of the microphone, instead of the sensitivity control voltage containing the variable voltage VR of the sensitivity adjuster between the condenser electrode pad Pᵢ and the ground pad P_{G}.

As shown in FIG. 6, the MEMS microphone chip M of the microphone device of the invention comprises a first electrode made of n-doped polysilicon which is a diaphragm electrode 23 formed on a base 21 as a support formed of the n-type silicon substrate through a silicon oxide film as an insulating film 22, and a second electrode made of n-doped polysilicon as a fixed electrode 26 arranged to oppose this first electrode. And, as shown in FIG. 1, the amplifier A for amplifying a signal from the condenser is mounted inside a container defined by the metal cap 101 and the mounting substrate 100. As shown in the appearance views (the top view, the side view and the bottom view) of FIGS. 3(a) to 3(c), the condenser electrode terminal Eᵢ which is the second electrode of the condenser, the voltage supply terminal Eᵥ connected to the amplifier A, the ground terminal E_{G} and the output terminal Eₒ from the amplifier A are led out of the container, and the pads (the condenser electrode pad Pᵢ, the voltage supply pad Pᵥ, the ground pad P_{G} and the output pad Pₒ from the amplifier (CMOS amplifier) A) are formed on the back side of the mounting substrate 100. That is, the condenser and the amplifier are mounted on a first surface of the mounting substrate 100. The terminals Eᵢ, Eᵥ, E_{G}, and Eₒ are mounted on a second surface, which is opposite to the first surface, of the mounting substrate 100.

As shown in FIG. 3, the condenser M and the CMOS amplifier A are mounted on the printed wiring substrate (circuit substrate) 100 in which a circuit pattern is formed, the inside of this microphone device is sealed with the metal cap 101, and the four pads described above, i.e., the condenser electrode pad Pᵢ, the voltage supply pad Pᵥ, the ground pad P_{G} and the output pad Pₒ are formed on the back side of this circuit substrate 100.

As shown in FIG. 6, the chip M for silicon microphone includes the n-type silicon substrate 21, the diaphragm electrode 23 as the first electrode functioning as one electrode of the condenser and made of a n-doped polysilicon film formed on the surface of the silicon substrate 21 through the silicon oxide film 22, a silicon oxide film as an electret film (a film targeted for electret: an inorganic dielectric film) 24, a spacer 25 made of a silicon oxide film, the fixed electrode 26 functioning as the other pole of the condenser, and a back air chamber 28 formed by etching the silicon substrate 21. A plurality of sound holes 27 (openings for guiding sound waves to the diaphragm electrode 23) are provided in the fixed electrode 26. In addition, reference numeral G shows an air gap and reference numeral H shows a contact hole for electrical connection.

The fixed electrode 26 is formed by laminating a silicon oxide film or a silicon nitride film and polysilicon having conductivity by n-doping.

The diaphragm electrode 23, the fixed electrode 26 and the inorganic dielectric film 24 forming the microphone are manufactured using a micromachining technique of silicon using the n-type silicon substrate 21 as a start material and a manufacturing process technique of a CMOS (complementary field-effect transistor), and configured as the so-called MEMS element.

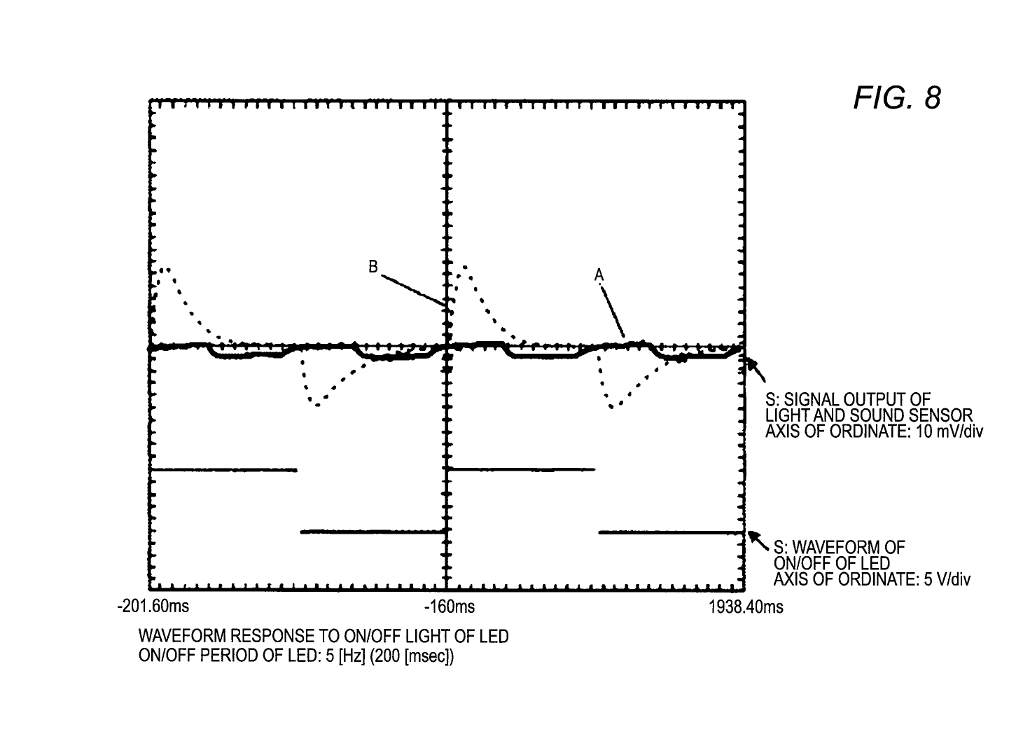

FIG. 7 is a diagram showing a result of measuring an output signal of the MEMS microphone in the presence of lighting of a fluorescent lamp, and FIG. 8 is a diagram showing an output by ON/OFF of LED light. In FIG. 7, the axis of ordinate shows a spectrum of an output voltage of the microphone of the invention and a conventional example at the time of turning on the fluorescent lamp of the inside of an anechoic room. In FIG. 7, A shows the output signal of the microphone of the conventional example. From this diagram, in the microphone of the invention, the output with respect to a flicker frequency of a Slight fluorescent lamp is not found. Also, according to FIG. 7, in the conventional example, the signal shows at a frequency corresponding to the frequency two times the commercial frequency which is a blink frequency of the fluorescent lamp and a remarkable light detection signal is found.

FIG. 8 is the output by ON/OFF of the LED light used in signal generation of light remote control, and a signal output A to the LED light of the microphone device of the invention becomes a signal smaller than that of a conventional product B. According to the invention from these comparisons, the output signal with high reliability can be supplied without outputting noise resulting from the blink of the fluorescent lamp.

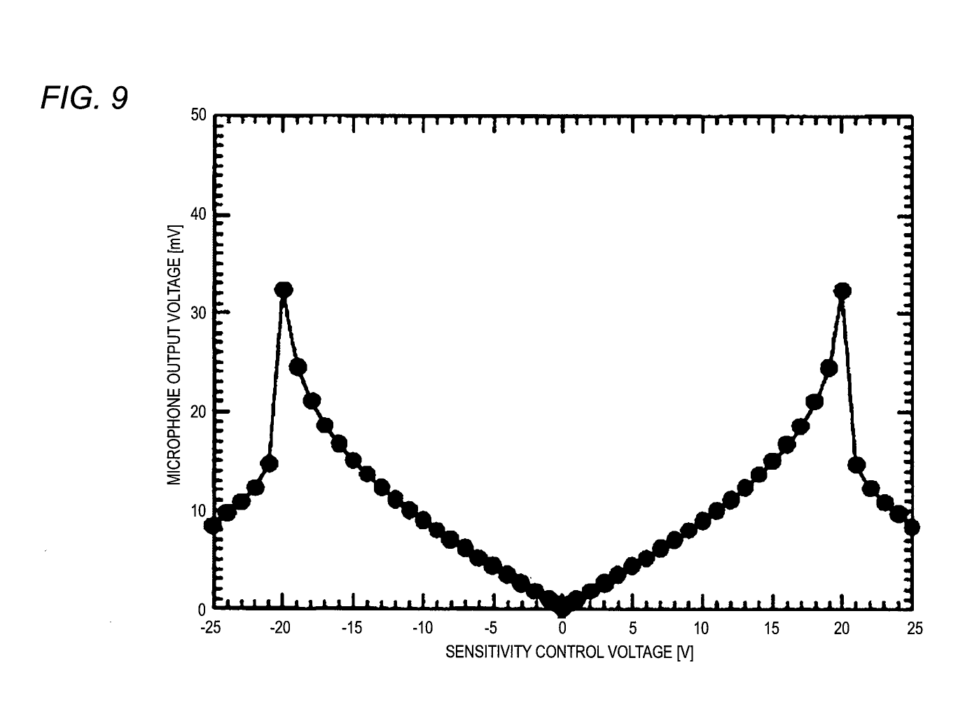

On the other hand, with respect to a sound signal, FIG. 9 shows sensitivity characteristics when magnitude of a voltage and polarity of the sensitivity control voltage are changed, and as a result of connecting a voltage adjuster made of the variable voltage VR and changing an applied voltage, sensitivity can be varied.

Therefore, variations in sensitivity can also be adjusted by this voltage control after the completion. Also, when changing the sensitivity at the time of use is desired, the desired sensitivity can be obtained extremely easily by only the voltage control.

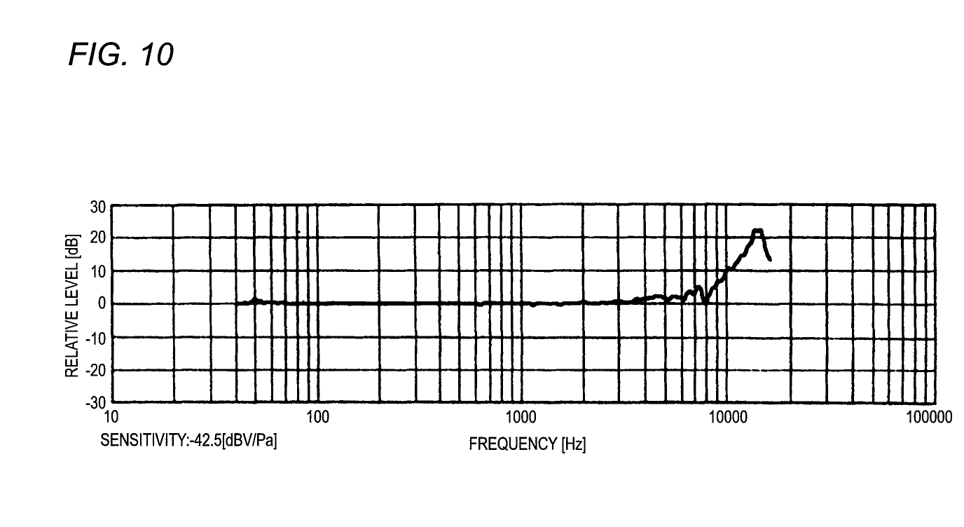

Also, as shown in FIG. 10, sensitivity frequency characteristics are sufficient characteristics as the microphone.

According to the embodiment herein, as shown in FIG. 6, for example, the insulating film 22 made of the silicon oxide film with a film thickness of about 700 nm is formed between the n-type silicon substrate 21 and the n-doped polysilicon film configuring the first electrode 23 formed on the surface of silicon substrate 21.

On the other hand, in the conventional microphone device, since a p-type silicon substrate is used, it can be considered that a MOS structure is formed by the first electrode 23 and between the p-type silicon substrate 21 and the second electrode 26 sandwiching the insulating layer 25 with about 3 μm, and it is considered that a depletion layer occurs on the side of the silicon substrate 21 in some form. When considering that a thickness of the depletion layer is modulated by the ON/OFF light of the LED or the blinking fluorescent lamp, modulation of capacity occurs, and the capacity modulation caused by this light is considered to be equal to an output voltage appears with the capacity changes caused by sound. Accordingly, it is estimated that a light modulated output may be obtained as an output. Therefore, in the conventional microphone device, the output corresponding to the modulated light and the output corresponding to the sound input appears on the same output line. On the other hand, according to the microphone device of the embodiment, since the n-type silicon substrate is used, such a light signal caused by photoelectric conversion can be suppressed.

By using the microphone device, acoustic signal with high accuracy can be output.

In the embodiment, the noise caused the light signal can be reduced particularly in the case of using the n-doped polysilicon layer in the n-type silicon substrate as the electrode. On the contrary, the light signal can also be reduced in the case of using a p-doped polysilicon layer in the p-type silicon substrate as the electrode. A crystal type of silicon forming these elements is not particularly limited to this combination, and may be selected from amorphous silicon, μ crystal silicon, polysilicon, single-crystal silicon and these combinations.

In the embodiment, the case where the first electrode has the same conduction type as the substrate is described, but in the case where the substrate and the second electrode, or the first electrode and the second electrode have opposite conduction types, the noise may be detected, and it is desirable that all have the same conduction type.

In the embodiment, the case of using the MEMS microphone device of the DC bias type has been described, but in addition to this, the invention can also target an electrostatic electro-acoustic converter of an electrets type.

The present application is based on Japanese patent application (patent application No. 2008-072011) filed on Mar. 19, 2008, and the contents of the patent application are hereby incorporated by reference.

### INDUSTRIAL APPLICABILITY

According to a microphone device of the invention, since a light signal can be reduced, and the microphone device is miniature and has high reliability, the invention can be widely used in an electret condenser microphone device, etc.

1. A microphone device comprising:
a condenser including a first electrode and a second electrode opposite to the first electrode, the first electrode and the second electrode being provided on a semiconductor substrate; and
an amplifier which is electrically connected to the condenser,
wherein each of the first electrode and the second electrode has the same conductivity type as the semiconductor substrate.

2. The microphone device according to claim 1, further comprising:
a mounting substrate;
a cap; and
a container defined by the mounting substrate and the cap,
wherein the condenser and the amplifier are housed inside the container

3. The microphone device according to claim 2, wherein light is introduced into the container.

4. The microphone device according to claim 3,
wherein the cap has an opening, and
the opening is disposed directly above the condenser.

5. The microphone device according to claim 2, further comprising:
a output terminal; and
a ground terminal,
wherein the condenser and the amplifier are mounted on a first surface of the mounting substrate,
the output terminal and the ground terminal are arranged on a second surface of the mounting substrate, the second surface is opposite to the first surface.

6. The microphone device according to any one of claims 1,
wherein the condenser includes an MEMS microphone.

7. The microphone device according to claim 1,
wherein the semiconductor substrate is made of n-type silicon substrate.

8. The microphone device according to claim 5,
wherein each of the first electrode and the second electrode is made of n-doped polysilicon.

9. The microphone device according to claim 1, further comprising
an electret film formed on the first electrode, the electret film being disposed between the first electrode and the second electrode.

10. The microphone device according to claim 9,
wherein the electret film and the first electrode are a diaphragm.
